(19) United States
(12) Patent Application Publication
(10) Pub. No.: US 2014/0379635 A1
(43) Pub. Date: Dec. 25, 2014

(54) System and Methods of Data Migration Between Storage Devices

(71) Applicant: Lexmark International Technologies S.A., Geneva (CH)

(72) Inventor: Ryan Timothy Sanford, South Saint Paul, MN (US)

(21) Appl. No.: 14/315,096

(22) Filed: Jun. 25, 2014

Related U.S. Application Data
(60) Provisional application No. 61/839,354, filed on Jun. 25, 2013.

(51) Int. Cl. G06F 17/30

(52) U.S. Cl. CPC G06F 17/303
USPC 707/609

(57) ABSTRACT

A method of migrating data includes calculating a datetime span within a date range, the datetime span having a start datetime and an end datetime calculated based upon a width value; searching a database for migration candidates from the one or more data records, the searching performed from the start datetime to the end datetime of the datetime span; if the searching the database for candidates between the start datetime and the end datetime of the datetime span returns at least one candidate, migrating the candidates to a second device; and if the searching the database for candidates within the datetime span does not return a candidate, incrementing the width value.

### CROSS REFERENCES TO RELATED APPLICATIONS

Pursuant to 35 U.S.C. §119, this application claims the benefit of the earlier filing date of provisional application Ser. No. 61/839,354, filed Jun. 25, 2013, entitled “System and Methods for Data Migration Between Storage Devices,” the contents of which is hereby incorporated by reference herein in their entirety. This patent application is related to the U.S. patent application Ser. No. ______, entitled, “System and Methods of Data Migration Between Storage Devices”, filed contemporaneously herewith and assigned to the assignee of the present application.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure relates generally to methods for migrating data between storage devices and, more particularly, efficient data migration between two storage devices.

2. Description of the Related Art

Data migration is the process of transferring or moving data from one storage location to another. With the increasing use and value of information, enterprises continue to seek reliable systems and methods to efficiently and quickly migrate data between two locations.

Typical data migration solutions often set a date range, or a start and an end date, to migrate data. However, there may be a time period within the date range that is considered a “dead zone”, or a period wherein there is no data to migrate.

Accordingly, there is a need for a seamless data migration process that transfers data from one storage device faster and more efficiently during one or more historical ranges. There is a need for a solution that dynamically selects the date ranges (e.g. start and end dates) and/or skips dead zones in a configured date range in order to perform the most optimal and most efficient data migration.

### SUMMARY

A system and methods of migrating data are disclosed. In one example embodiment, the method of migrating data includes calculating a time span within a date range, the time span having a start time and an end time calculated based upon a width value; searching a database for migration candidates from the one or more data records, the searching performed from the start time to the end time of the time span; if the searching the database for candidates between the start time and the end time of the time span returns at least one candidate, migrating the candidates to a second device; and if the searching the database for candidates within the time span does not return a candidate, incrementing the width value.

In one example embodiment, the method of migrating data records includes receiving a date range for migrating the one or more data records from a first device to a second device; creating a time span having a width value; searching a database for migration candidates from the one or more data records, the searching performed within the time span at the value of the width. If the searching the database for candidates within the time span returns at least one candidate, migrating the candidates to the second device; and if the searching the database for candidates within the time span does not return a candidate, incrementing the value of the width. In one example aspect, the migrating may include incrementing the time span by the value of the width. In another example aspect, the value of the width at the time the time span is created may be set to one hour.

In another example embodiment, the method of migrating data records may include receiving a start date and an end date to start and end migrating one or more data records from a first device to a second device, respectively; creating a time span with an initial width value, the time span beginning at the start date; searching the database for data records available for migration within the time span; if at least one data record is determined to be available for migration within the time span, migrating the at least one data record to the second device; and setting the width to the initial value; and if no data record is determined to be available for migration within the time span, incrementing the width.

In yet another example embodiment, the method of migrating data may include receiving a date range having a start and an end date for migrating data; creating a time span between the date range, the time span having a width; determining if the time span is less than the end date of the date range, and upon positive determination, searching a database for candidates within the time span; if the searching of the database for candidates within the time span returns at least one candidate, migrating the at least one candidate to the destination device; if the searching the database for candidates within the time span does not return a candidate, determining if the value of the width is less than a pre-configured number of hours and upon positive determination, incrementing the value of the width by one hour.

From the foregoing disclosure and the following detailed description of various example embodiments, it will be apparent to those skilled in the art that the present disclosure provides a significant advance in the art of methods of migrating data records from a source device to a destination device through variable time spans for migrating the data records. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is an example embodiment of a system for performing an example migration of data from one device to another.

FIG. 2 is an example method of migrating data from a migration source device to a migration destination device with candidate search range improvement.

FIG. 3 is an example method of migrating data from a migration source device to a migration destination device with candidate location improvement.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

Disclosed are a system and methods for migrating data from one storage device to another. A method is disclosed that allows a migration tool to pass more quickly through one or more historical ranges where there is little to no data to migrate. A method is also disclosed that provides automatic date range adjustment for a migration tool to exclude periods with data records that have been migrated when the tool is restarted.

For purposes of the present disclosure, it will be appreciated that the content may refer to files such as, for example, documents, image files, audio files, among others. Content may refer to paper-based records converted into digital files to be used by a computing device. Content may also refer to information that provides value for an end-user or content consumer in one or more specific contexts. Content may be shared via one or more media such as, for example, computing devices in a network.

In an example embodiment, content may refer to computerized medical records, or electronic medical records (EMR), created in a health organization, or any organization that delivers patient care such as, for example, a physician's office, a hospital, or ambulatory environments. EMR may include orders for drug prescriptions, orders for tests, patient admission information, imaging test results, laboratory results, and clinical progress information, among others.

Content may also refer to an electronic health record (EHR) which may be a digital content capable of being distributed, accessed or managed across various health care settings. EHRs may include various types of information such as, for example, medical history, demographics, immunization status, radiology images, medical allergies, personal states (e.g. age, weight), vital signs and billing information, among others. EHR and EMR may also be referred to as electronic patient record (EPR). The terms EHR, EPR, EMR, document, content, object and assets may be used interchangeably for illustrative purposes throughout the present disclosure.

In another example embodiment, content may also refer to DICOM images. DICOM is a standard or specification for transmitting, storing, printing and handling information in medical imaging. Medical imaging, as will be known in the art, may refer to a process and/or technique used to generate images of the human body, or parts or functions thereof, for medical and/or clinical purposes such as, for example, to diagnose, reveal or examine a disease. The standard set by DICOM may facilitate interoperability of various medical imaging equipment across a domain of health enterprises by specifying and/or defining data structures, workflow, data dictionary, and compression, among other things, for use to generate, transmit and access the images and related information stored on the images. DICOM content may refer to medical images following the file format definition and network transmission protocol as defined by DICOM. DICOM content may include a range of biological imaging results and may include images generated through radiology and other radiological sciences, nuclear medicine, thermography, microscopy, and medical photography, among many others. DICOM content may be referred to hereinafter as images following the DICOM standard, and non-DICOM content for other forms and types of content, as will be known in the art.

Content may be generated and maintained within an institution such as, for example, an integrated delivery network, hospital, physician's office or clinic, to provide patients and health care providers, insurers or payers access to records of a patient across a number of facilities. Sharing of content may be performed using network-connected enterprise-wide information systems, and other similar information exchanges or networks, as will be known in the art.

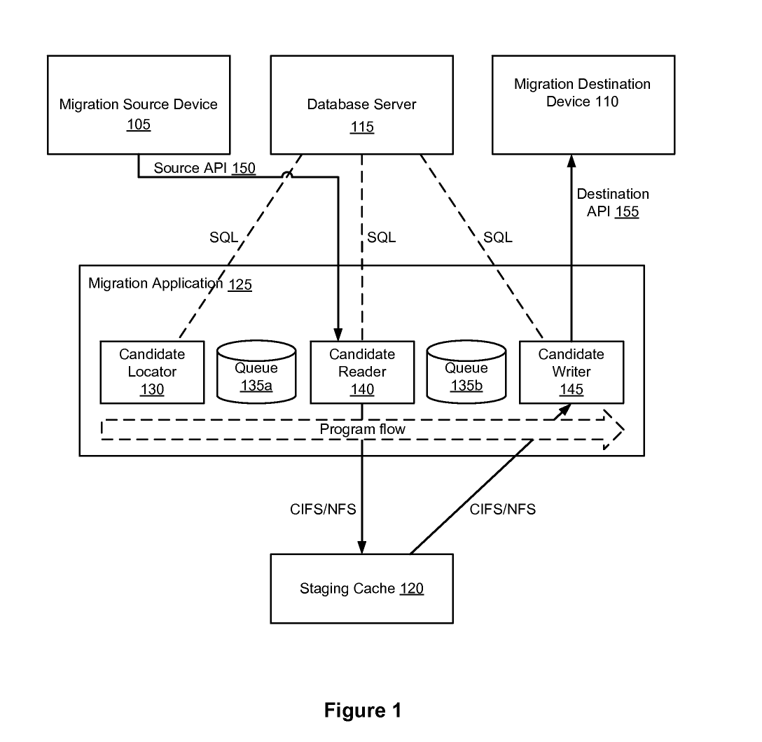

FIG. 1 shows an example system for performing the method of seamless data migration between one or more storage devices. System 100 includes a migration source device 105, a migration destination device 110, a database server 115, a staging cache 120, and a migration application 125. Migration application 125 includes one or more components such as a candidate locator 130, a reader queue 135a, a writer queue 135b, a candidate reader 140 and a candidate writer 145.

Migration source device 105 and migration destination device 110 are computer readable storage media for storing content from at least one content source. Migration source device 105 and migration destination 110 may be databases for storing content to be used by at least one enterprise or organization. Each of migration source device 105 and migration destination device 105 may be storage platforms for storing, archiving and accessing content. In one example embodiment, migration source device 105 and migration destination device 110 may be cloud storage platforms.

Migration source device 105 and migration destination device 110 may be content-addressable storage (CAS) devices. CAS devices refer to devices that store information that are retrievable based on the content of the information, and not based on the information's storage location. CAS devices allow a relatively faster access to fixed content, or stored content that is not expected to be updated, by assigning the content a permanent location on the computer readable storage medium. CAS devices may make data access and retrieval up-front by storing the object such that the content cannot be modified or duplicated once it has been stored on the memory. In alternative example embodiments, storage devices may be Grid, NAS, and other storage systems as will be known in the art.

Examples of migration source device 105 and migration destination device 110 include Atmos®, StorageGRID®, Sonas®, Nirvanix®, among many others. Any other forms and types of storage devices and platforms may be used as at least one of migration source device 105 and migration destination device 110, as will be known in the art.

Database server 115 may be a computing device that serves as a server for storing one or more databases. Database server 115 may be used to store one or more candidates for migration, which will be used in conjunction to a method as will be discussed in greater detail below. In one example embodiment, database server 115 may be a SQL database server.

Staging cache 120 may be a network-attached storage (NAS) device used by migration application 125. Staging cache 120 may be a file-level computer readable storage medium that is connected to a computing device network. Staging cache 120 may provide data access to one or more group of clients which may or may not use different types of computational units. In one example embodiment, staging cache 120 may be a specialized NAS device having a customized hardware, software, or a configuration of any of the two elements, for use in the seamless migration of data.

In another example embodiment, staging cache 120 may be one of a plurality of networked appliances that contain at least one hard drive and provide access to content using network file sharing protocols such as, for example, Server Message Block (SMB), Network File Storage (NFS), among many others. In yet another example embodiment, staging cache 120 may be a computing device connected to the network illustrated in system 100 that provides file-based storage service to other devices on system 100.

Migration application 125 may be a subsystem containing one or more computing devices connected to each other by one or more communication links, as will be known in the art. Migration application 125 may include a candidate locator 130, a reader queue 135a, a writer queue 135b, a candidate reader 140 and a candidate writer 145 that perform one or more methods for migrating data from migration source device 105 to migration destination device 110. In one example embodiment, candidate locator 130, reader queue 135a, writer queue 135b, candidate reader 140 and/or candidate writer 145 may not be part of migration application 125 but rather are communicatively coupled or connected to migration application 125, or to at least one computing device in migration application 125. In one alternative example embodiment, candidate locator 130, reader queue 135a, writer queue 135b, candidate reader 140 and candidate writer 145 may be software applications running on migration application 125.

In yet another example embodiment, candidate locator 130, candidate reader 140 and candidate writer 145 may be three types of worker threads and reader queue 135a and writer queue 135b may act as buffers between the worker threads to reduce the amount of time a worker thread type is idle, as well as to allow container sizes to change between migration source device 105 and migration destination device 110.

Candidate locator 130 may query database server 115 for candidate assets which are stored on migration source device 105 and need to be migrated to migration destination device 110. In an example embodiment, candidate locator 130 may be one thread in migration application 125. Reader queue 135a may be a queue for candidate reader 140.

Candidate reader 140 may be a configurable number of threads in migration application 125. The number of threads in candidate reader 140 may be configured using a parameter in a settings file and/or function included in migration application 125 (not shown). Candidate reader 140 picks up candidates in reader queue 135a, reads the asset containers off of migration source device 105, writes the asset containers to staging cache 120, updates database server 115 to reflect the new location of the assets, and puts the assets in writer queue 135b, for access by candidate writer 145.

Candidate writer 145 may be a configurable number of threads in migration application 125. The number of candidate writer 145 threads may be configured using a parameter in a settings file and/or a function of migration application 125 (not shown). Candidate writer 145 picks up candidates from writer queue 135b, builds a new container and writes the new container to migration destination device 110, removes the assets from the staging cache 120 and updates database server 115 to reflect the new location of the assets.

Migration source device 105 may send data to be migrated to candidate reader 140 of migration application 135 using one or more functions by a source application programming interface (API). Source API may be a specification of one or more data structures, variables, routines and variables provided by migration source device 105 and may vary based on the type of migration source device 105 used in system 100.

Migration destination device 110 may also receive the data to be migrated from candidate writer 145 using one or more functions by a destination API 155. Similar to source API, destination API may be a specification provided by migration destination device 110 and is based on the type of device used.

Communication between each of candidate locator 130, candidate reader 140 and candidate writer 145 to database server 115, respectively, may be performed using one or more SQL functions. It will be appreciated that SQL is used for illustrative purposes and other types of communication between one or more threads and a database server may be used.

Candidate reader 140 may transmit candidates to staging cache 120 through Common CIFS and/or NFS protocols. Staging cache 120 may also transmit candidates to candidate writer 145 for writing to migration destination device 110 using CIFS or NFS. CIFS and NFS are different standards for computing devices to share files across a network. The use of CIFS and NFS to transfer or share files in system 100 is illustrative and other file sharing standards and protocols may be used.

Each of the components in system 100 may include one or more processors communicatively coupled to a computer readable storage medium having computer executable program instructions which, when executed by the processor(s), cause the processor(s) to perform the steps described herein. The storage medium may include read-only memory (ROM), random access memory (RAM), non-volatile RAM (NVRAM), optical media, magnetic media, semiconductor memory devices, flash memory devices, mass data storage devices (e.g., a hard drive, CD-ROM and/or DVD units) and/or other memory as is known in the art. The processor(s) execute the program instructions to receive and send electronic medical images over a network. The processor(s) may include one or more general or special purpose microprocessors, or any one or more processors of any kind of digital computer. Alternatives include those wherein all or a portion of the processor(s) is implemented by an application-specific integrated circuit (ASIC) or another dedicated hardware component as is known in the art.

The components in system 100 may be connected in a local area network (LAN) through one or more communication means in order to transmit and request content between each other. Other networks such as, WAN, wireless, among others, may also be utilized, as will be known in the art, to connect the computing devices in the system.

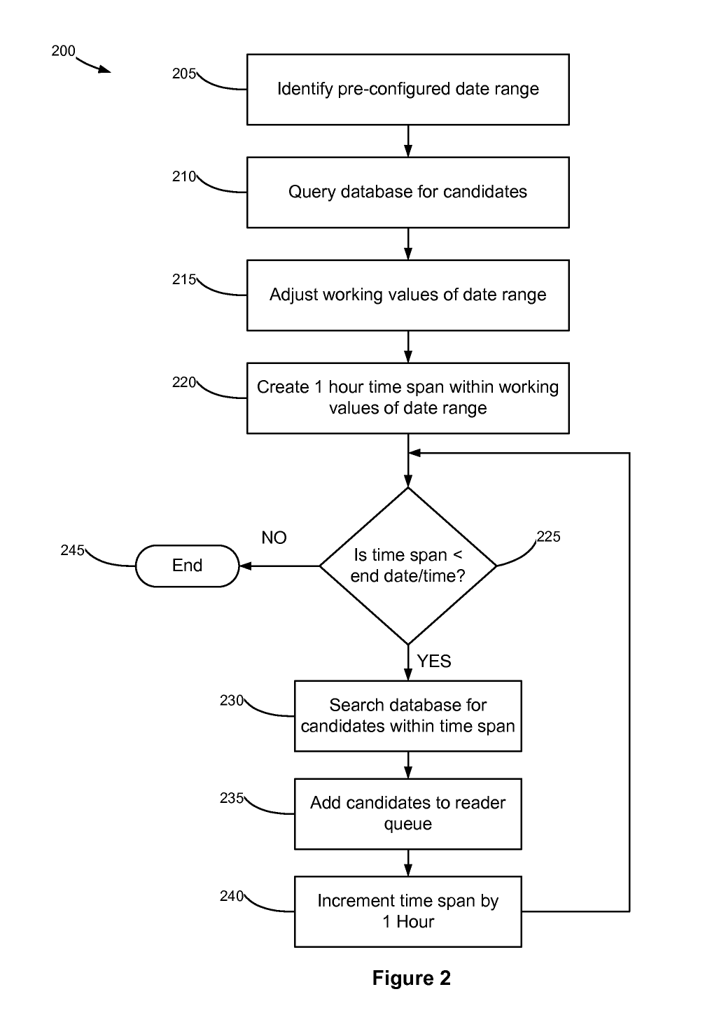

FIG. 2 is an example method 200 of migrating data from migration source device 105 to migration destination device 110 with a candidate search date range improvement. Method 200 may include reading a configured date range, querying database server 115 for candidates to be migrated, adjusting the date range to the optimal date range that excludes periods with previously migrated data, creating a time span, searching database server 115 for candidates within the time span, and adding candidates to one or more queues for migrating to migration destination device 110.

Date range may refer to a period of time for migrating candidate data records from migration source device 105 to migration destination device 110. Date range typically reflect the transaction time of the data records, such as, for example, the date each of the data records have been committed to database server 115. Date range may also refer to a datetime value which may be in the format of days, months, years, hours, minutes and seconds, as will be known in the art.

Method 200 allows migration application 125 to dynamically adjust a pre-configured date range to exclude periods in the pre-configured date range where data has already been migrated, and instead, perform data migration in previously un-migrated periods. Method 200 may be performed when migration application 125 is restarted to skip periods in a date range with data that have already been migrated.

Method 200 may be performed using the example pseudo-code as follows:

```
1. Read configured start (START_TIME) and end (END_TIME)
  date/time.
2. Query database and adjust working values of START_TIME and
  END_TIME.
3. Create 1 hour time span (tsHour) starting at configured start
  date/time.
4. While (tsHour < END_TIME)
```

4.1. Search database for candidates within tsHour
4.2. Add candidates to the reader queue
4.3. Increment tsHour by 1 hour

At block 205, a pre-configured date range may be identified. Identifying a pre-configured date range may include reading a pre-configured start time and end time. Each of the start time and the end time may include a date and a time which data is migrated from migration source device 105 to migration destination device 110. The pre-configured date range may be configured by an authorized user of migration application 125.

At block 210, database server 115 may be queried for items or rows that have not been migrated. In one example embodiment, one row or record per content (e.g. file or DICOM instance) is stored in database server 115. The record contains an identifier or location of the content on migration source device 105, and a foreign key to another database table in database server 115. The foreign key describes connected parameters for the migration source device. Querying database server 115 identifies candidates, or records which exist in migration source device 105, that have not been previously migrated, and may need to be migrated using example method 200.

At block 215, the pre-configured date range may be adjusted based on the results of the querying performed on database server 115 at block 210. The adjusted date range is dynamically selected prior to migration of data to determine the working date range to which data may be migrated. Dynamically selecting the date range to create an adjusted date range is performed in order to exclude periods within the pre-configured date range having no candidates (e.g. periods having items that have been previously migrated), and only perform a migration process on time periods with content that have yet to be migrated from migration source device 105 to migration destination device 110. In one example aspect, the pre-configured date range may be narrowed to create the adjusted date range for migrating data and exclude the periods that contain no candidates for migration.

At block 220, a one-hour time span is created with a value that falls within the adjusted working values of the date range. The one-hour time span is used to search for candidates having transaction times within the adjusted date range.

At block 225, it is determined if the value of time span is less than the adjusted value of end date/time. When the value of time span is less than the end date/time, the migration process is determined to be incomplete for candidates having transaction times that fall within the working values of the date range set at block 210, and the migration process of example method 200 proceeds to block 230 where database server 115 is searched for candidates that fall within the adjusted date range. Transaction time may be the time that a candidate is entered into a memory of database server 115.

At block 235, the searched candidates are added to reader queue 135a and are prepared for migration from migration source device 105 to migration destination device 110 through migration application 125. Preparing the searched candidates for migration may include retrieving the candidates from the reader queue 135a by candidate reader 140, identifying the asset containers from migration source device 105, taking out or extracting the assets from their asset containers, writing the assets to staging cache 120, updating database server 115 to reflect the new location of the candidates, and placing the candidates in writer queue 135b for writing in migration destination device 110. Candidate writer 145 may also be used to pick up the candidates from writer queue 135b, build a new container, write the new container to migration destination device 110, remove the files from staging cache 130, and update database server 115 to reflect the new location of the files.

At block 240, the time span may be incremented by one hour to continue searching for candidates within the next hour as long as the value of time span is less than the working value of the end date/time. It will be understood that the one hour added to time span is for illustrative purposes and that the time span may be incremented by other values, as will be known in the art.

If it is determined at block 225 that the value of time span is equal or greater than the working value of the end date/time, the migration process of example method 200 is complete and candidates that fall within the adjusted date range have been successfully migrated from migration source device 105 to migration destination device 110. When value of time span is equal or greater than the working value of the end date/time, the process ends at block 245.

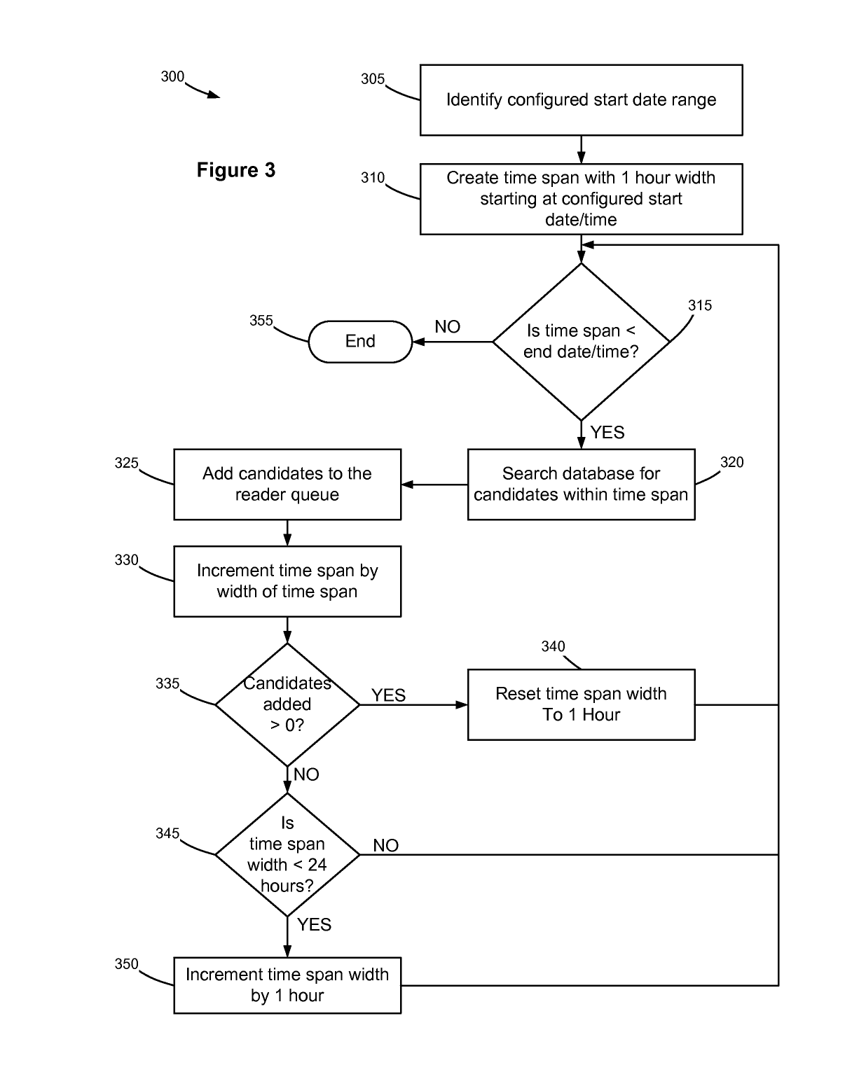

FIG. 3 is an example method 300 of migrating data from migration source device 105 to migration destination device 110 with candidate location improvement. Method 300 may include identifying a configured date range, creating a time span with one hour width starting at configured start time of the identified date range, searching database server 115 for candidates within the time span, and adding candidates identified from database server 115 to reader queue 135a for migrating to migration destination device 110.

A time span may refer to a datetime value that may be derived within the date range and may be calculated based on a time width, as will be discussed in greater detail below. Time span may include a start datetime and an end datetime for use in searching data records having transaction times that fall within the time span. The width may refer to a period of time in at least one of days, months, years, hours, minutes and seconds by which to increment the time span.

Method 300 allows migration application 125 to dynamically search date ranges in order to pass more quickly through date ranges (e.g. nights/weekends/holidays) when there is likely nothing to migrate.

Method 300 may be performed using the example pseudo-code as follows:

```
1. Read configured start (START_TIME) and end (END_TIME)
  date/time
2. Create time span (tsRange) with 1 hour width starting at
  configured start date/time
3. While (tsRange < END_TIME)
```

3.1. Search database for candidates within tsRange
3.2. Add candidates to the reader queue.
3.3. Increment tsRange by width of tsRange
3.4. If (candidates added > 0)

3.4.1. Reset tsRange width to 1 hour
3.4.2. continue

3.5. If (tsRange width < 24 hours)

3.5.1 Increment tsRange width by 1 hour
3.5.2 continue

At block 305, a configured date range may be identified. The configured date range may include a start date/time and an end date/time that is pre-configured by an authorized user to start and end the migration of data from migration source device 105 to migration destination device 110. The date range indicates the time period to perform the migration process using components of system 100.

At block 310, a time span may be created with one hour width starting at configured start date/time of the identified date range. The one hour width is set for illustrative purposes and it will be appreciated that other values for the time span width may be used. In the above-mentioned example pseudo-code for performing method 300, the time span may have a variable name tsRange for reference in the present disclosure.

At block 315, the value of time span may be determined to be less than the end date/time of the identified date range at block 305. If the time span is less than the end date/time, which indicates that the migration process has yet to be completed, database server 115 may be searched for candidates within the time span (at block 320). Searching the database for candidates within the time span includes searching for data records having transaction times that fall within the time span. A transaction time may refer to date and time the data records have been originally committed to database server 115.

At block 325, candidates that are queried from database server 115 are added to reader queue 135a by candidate locator 130. Querying the candidates from database server may be performed by candidate locator 130. Adding the candidates to reader queue 135a is performed in order to reduce the amount of time candidate locator 130 remains idle during the migration process of example method 300.

It will be understood that when candidates are written to reader queue 135a, the candidates are to be migrated to migration destination device 110 by way of candidate reader 140, which picks up the candidates in the reader queue 135a, reads the asset containers from migration source device 105, takes out or extracts the assets from the asset containers, writes the assets to staging cache 120, updates database server 115 to reflect the new location of the candidates, and places the candidates in writer queue 135b for writing in migration destination device 110. Candidate writer 145 may also be used to pick up the candidates from writer queue 135b, build a new container, write the new container to migration destination device 110, remove the files from staging cache 130, and update database server 115 to reflect the new location of the files.

At block 330, time span may be incremented by the width value of the time span set at block 310. For illustrative purposes, the time span in example method 300 may be incremented by one.

At block 335, the number of candidates added to reader queue 135a is identified. If there is at least one candidate added to reader queue 135a, time span width is reset to 1 hour (at block 340) and the process goes back to block 315 to determine if the migration process has not been completed and to re-perform the searching of candidates from database server 115 (at block 320), the adding of candidates to the reader queue (at block 325), and the incrementing of the time span by the width of the time span (at block 330), etc.

If it is determined at block 335 that there are no candidates queried from database server 115 within the current time span value, the value of the time span width is identified (at block 345).

If the current value of the time span width is determined to be greater than or equal to 24 hours, the process goes back to block 315 and performs the processes indicated by blocks 315 and onwards. However, if at block 345, it is determined that the time span width is less than 24 hours, the time span width is incremented by one hour (at block 350), and the process then goes back to block 315 to determine if the migration process has been completed within the configured date range. Incrementing the time span width by one hour if there are no candidates within the time span and if the time span width is less than 24 hours allows the migration process of example method 300 to pass more quickly through date ranges where there is no candidate to migrate.

If at block 315, it is determined that the value of time span is equal or greater than the end date/time of the configured date range, the migration process of method 300 is determined to be complete and the method ends at block 355.

It will be understood that the example applications described herein are illustrative and should not be considered limiting. It will be appreciated that the actions described and shown in the example flowcharts may be carried out or performed in any suitable order. It will also be appreciated that not all of the actions described in FIGS. 2 and 3 need to be performed in accordance with the embodiments of the disclosure and/or additional actions may be performed in accordance with other embodiments of the disclosure.

Many modifications and other example embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of migrating data records, comprising:
calculating a datetime span within a date range, the datetime span having a start datetime and an end datetime calculated based upon a width value;
searching a database for migration candidates from the one or more data records, the searching performed from the start datetime to the end datetime of the datetime span;
if the searching the database for candidates between the start datetime and the end datetime of the datetime span returns at least one candidate, migrating the candidates to a second device; and
to if the searching the database for candidates within the datetime span does not return a candidate, incrementing the width value.

2. The method of claim 1, wherein the candidates are data records entered into the database at a datetime that falls between the start datetime and the end datetime of the datetime span.

3. The method of claim 1, wherein the calculating the datetime span includes creating a datetime span that starts at a start date and datetime of the date range.

4. The method of claim 1, further comprising, incrementing the datetime span by the width value.

5. The method of claim 1, wherein if the searching the database for candidates returns at least one candidate, resetting the width value to an initial width value.

6. The method of claim 1, wherein the date range includes an end date and the searching the database is performed while the start datetime and the end datetime of the datetime span is determined to be less than the end date.

7. The method of claim 1, wherein the incrementing the width value is performed if the width value is less than 24 hours.

8. A method of migrating data records, comprising:
calculating a datetime span within a date range, the datetime span having a start and end times set using an initial width value;
searching the database for data records available for migration between the start and end times of the datetime span;
if at least one data record is determined to be available for migration between the start and end times of the datetime span,
migrating the at least one data record to a second device; and
setting the width value to the initial value; and
if no data record is determined to be available for migration between the start and end times of the datetime span, incrementing the width value.

9. The method of claim 8, wherein the data records available for migration are data records entered into the database at a datetime between the start and end times of the datetime span when the searching is performed.

10. The method of claim 8, wherein the width is incremented by a preconfigured value.

11. The method of claim 8, wherein the incrementing the width is performed if the width is less than a preconfigured datetime limit.

12. The method of claim 8, wherein the migrating the at least one data record to the second device includes updating a location entry of the at least one data record in the database with a new location of the at least one data record in the second device.

13. The method of claim 8, further comprising determining if the end datetime of the datetime span is less than an end date of the date range.

14. The method of claim 13, wherein if the end date of the datetime span is determined to be less than the end date of the date range, performing the searching the database.

15. The method of claim 8, wherein the data records available for migration are data records on the database that have not been previously migrated to the destination device.

16. A computing device having a non-transitory computer readable storage medium for performing one or more instructions for migrating data from a source device to a destination device, the one or more instructions comprising:
calculating a start and end times of a datetime span within a date range having a start and end date and times, the datetime span having a width value;
determining if the end datetime of the datetime span is less than the end date of the date range, and upon positive determination, searching a database for candidates between the start and end times of the datetime span;
if the searching of the database for candidates returns at least one candidate, migrating the at least one candidate to the destination device;
if the searching the database for candidates does not return a candidate, determining if the width value is less than a pre-configured number of hours and upon positive determination, incrementing the width value by a preconfigured value.

17. The computing device of claim 16, wherein the candidates are data records entered in the database at a datetime within the datetime span that the candidates are searched.

18. The computing device of claim 16, wherein the instruction for migrating the candidates includes assigning a location in the destination device for each of the candidates found within the datetime span.

19. The computing device of claim 18, wherein the instruction for migrating the at least one candidate further includes updating the database to reflect the location of each of the candidates found within the datetime span.

20. The computing device of claim 16, wherein an initial start date of the datetime span begins at a start datetime of the date range.
